(19) United States
(12) Patent Application Publication
(10) Pub. No.: US 2017/0074351 A1
(43) Pub. Date: Mar. 16, 2017

(54) SYNTHETIC ROPE SOCKET

(71) Applicant: WASHINGTON CHAIN & SUPPLY, INC., SEATTLE, WA (US)

(72) Inventors: GABRIEL BENAVIDEZ, Woodinville, WA (US); STEVE ROW, Federal Way, WA (US); LANCE EGGERS, Seattle, WA (US); RAYMOND DOUGLAS CUTSINGER, Porter, TX (US)

(73) Assignee: WASHINGTON CHAIN & SUPPLY, INC.

(21) Appl. No.: 14/850,610

(22) Filed: Sep. 10, 2015

(51) Int. Cl. F16G 11/04

(52) U.S. Cl. CPC F16G 11/04

(57) ABSTRACT

A device and method for the end termination of a braided synthetic rope, with a tapered wedge seated inside a wedge socket free of sharp edges, with a screw-on cap at the top of the wedge socket with an eye for attachment for connecting links, slots in the wedge for receiving unbraided individual strands of a braided synthetic rope. In addition, the device includes a spring and a steel plunger to be inserted in the screw-on cap to assist in holding the wedge securely in place once it is installed in the wedge socket. Rounded edges at the bottom of the wedge socket help protect the braided synthetic rope from abrasion and cutting while in service. The device is intended to create a safe and efficient manner to connect objects in the mooring industry such other synthetic mooring lines, anchor chains, and wire ropes.

### BACKGROUND

The invention relates to a device and method for the end termination of a braided synthetic mooring line that is currently being used in the mooring of any or all offshore drilling, and production facilities. Moreover the invention relates to a preferably alloy metal termination of braided synthetic mooring lines which will enhance the protection of mooring lines at the end fitting, will reduce installation times in turn reducing costs, and will utilize standard wire rope, and/or chain connectors. The device and method is intended to create a safe and efficient manner to connect objects in the mooring industry such other synthetic mooring lines, anchor chains, and wire ropes.

The offshore oil production industry, due to the increased demand from the marketplace for oil production, has constantly improved their technology and capabilities to explore and to drill in deeper waters. While ongoing upgrades are taking place on the current drilling fleets the weight increases that they are subjected to because of longer and heavier mooring lines, an alternative innovation solution had to be explored to address these issues. Braided synthetic ropes are being used much more often to replace the heavier more cumbersome steel wire rope thus requiring synthetic ropes to undergo many changes in design and use. The synthetic rope fittings have been large, heavy and cumbersome resulting in long installation times, increased labor hours, and safety concerns for employees. The braided synthetic rope socket of this invention helps to resolve many of these issues. The current method of braiding a synthetic rope and installing a thimble in the eye of the rope is time consuming and expensive. The advantages of the inventive synthetic rope socket is that it can be installed on a braided synthetic rope and fitted with any custom end connection required for terminating the synthetic rope. The braided synthetic rope socket can also be adapted with a special fitting to join two synthetic lines together for spooling purposes speeding up the process without causing any damage to the synthetic ropes. Due to the design of the braided synthetic rope socket of the present invention there are no sharp or mitered edges to cut or cause abrasions, all corners or edges are rounded to protect the integrity of the synthetic rope.

Previous rope end termination devices are depicted in U.S. Pat. No. 5,735,628 and U.S. Pat. No. 8,607,417 B2.

### SUMMARY OF THE INVENTION

The inventive synthetic rope socket includes a braided rope wedge and wedge socket with screw on cap used for the end termination of braided synthetic ropes offering sufficient strength and ease of connections. With the design of this apparatus it will allow for quick and efficient field assembly without the need for splicing of an eye and installation of a rope thimble. The design of the apparatus will allow for the connection of synthetic ropes to other devices such as chains, wire ropes, and even other synthetic ropes without the need for intermediate hardware designed for the protection of the synthetic rope. The apparatus also has the capabilities of being customized to fit any connection point with the removable screw cap.

It is an object of this invention to provide a device for the end termination of braided synthetic rope with a multiplicity of braided strands, with a tapered wedge with a rope entry end, a top end with rounded surfaces, extending from the rope entry end to the top end, and a multiplicity of longitudinal exterior wedge slots to receive strands unbraided from the synthetic rope at the end termination after being extended through the wedge from the rope entry end to the top end, said strands being rebraided into the synthetic rope at the rope entry end of the wedge after being folded back and placed in the wedge slots, a wedge socket with a rope entry end, a rope entry end opening with rounded edges at the rope entry end for insertion of the braided synthetic rope before said rope is extended through the wedge, a wedge entry end, a tapered wedge seat to receive the tapered wedge, internal threads in the tapered wedge seat at the wedge entry end, a screw-on cap having a wedge socket engagement end and a fitting end with external threads, coaxial plunger and spring at the wedge socket engagement end for threaded engagement with the internal threads in the tapered wedge seat at the wedge entry end after the tapered wedge is seated in the wedge socket, and a socket fitting fixedly attached to the fitting end of the screw-on cap.

It is also an object of this invention to provide a method for the end termination of braided synthetic rope with a multiplicity of braided strands, comprising the steps of: inserting the end of a braided synthetic rope through a wedge socket with a rope entry end, a rope entry end opening with rounded edges at the rope entry end, said wedge socket also having a wedge entry end, a tapered wedge seat to receive a tapered wedge, and internal threads in the tapered wedge seat at the wedge entry end; inserting the end of the braided synthetic rope after being inserted through the wedge socket into and through a tapered wedge with a rope entry end, a top end with rounded surfaces, extending from the rope entry end to the top end, and a multiplicity of longitudinal exterior wedge slots; unbraiding the strands from a portion of the end of the braided synthetic rope extending from the top end of the tapered wedge; folding the unbraided strands back over the tapered wedge into the wedge slots; rebraiding the unbraided strands extending past the wedge slots into the synthetic rope in proximity of the wedge rope entry end; pulling the synthetic rope to draw and seat the tapered wedge with unbraided strands placed in the wedge slots in the wedge socket, and; at the wedge entry end of the wedge socket threading a screw-on cap with a fixed socket fitting, with external threads, a coaxial plunger and spring into the internal threads of the wedge socket, said plunger engaging the top end of the wedge and securing it in the wedge socket.

### BRIEF DESCRIPTION OF THE DRAWINGS

For a further understanding of the nature, objects and advantages of the invention, reference should be had to the following detailed description, read in conjunction with the following drawings.

FIG. 1 is a side cross sectional view of the wedge socket of the inventive synthetic rope socket.

FIG. 2 is a side cross sectional view of the synthetic rope wedge of the inventive synthetic rope socket.

FIG. 3 is a top view of the synthetic rope wedge.

FIG. 4 is a side view of the synthetic rope wedge.

FIG. 5 is a side view of the wedge socket and wedge prior to pulling the wedge into the socket.

FIG. 6 is a side cross sectional view of the wedge socket with the rope and wedge pulled back and seated inside the wedge socket.

FIG. 7 is a side cross sectional view of the complete and assembled braided synthetic rope socket.

### DETAILED DESCRIPTION OF THE INVENTION

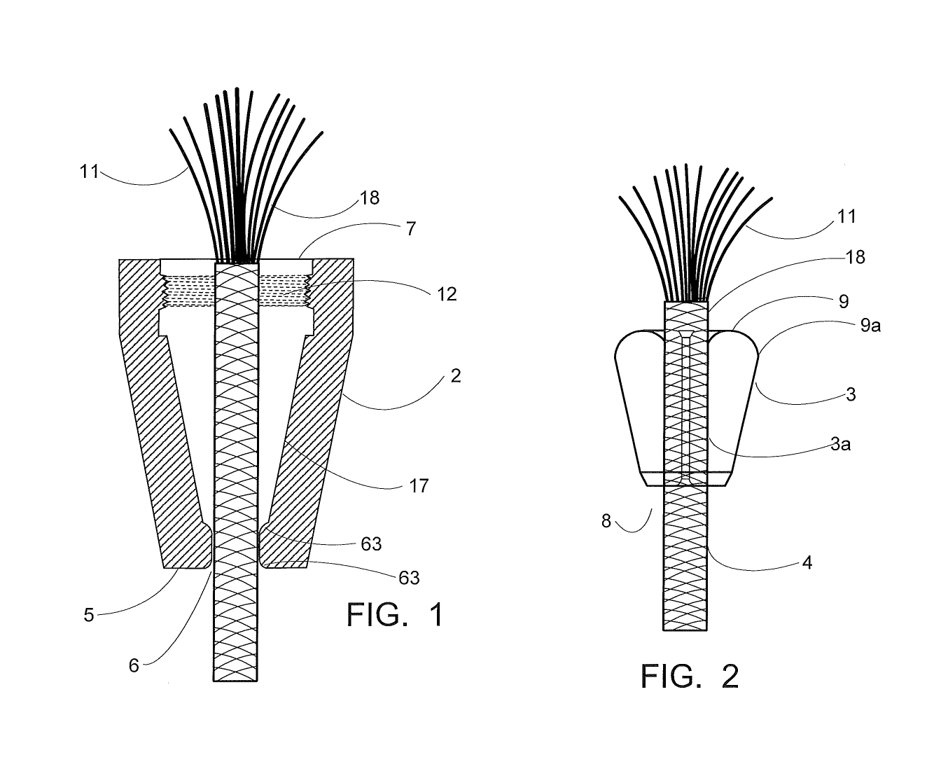

FIG. 1 shows a wedge socket 2 of the inventive synthetic rope socket 1 with a wedge entry end 7 and a rope entry end 5 with a rope entry opening 6 that allows a braided synthetic rope 4 with a multiplicity of braided strands 11 to pass through the rope entry opening 6 without interruption. In the wedge socket 2 is a tapered wedge seat 17 to allow a wedge to seat in when pulled back to a seated position. Other features of the wedge socket 2 are rounded edges 6a for the protection of the braided synthetic rope 4, tapered walls to receive the braided rope wedge and internal threads 12 at the wedge entry end 7 of the wedge socket to receive a screw-on cap and end termination. Also shown are unbraided rope strands 11 at the unbraided end 18 of the braided synthetic rope 4 inserted through the wedge socket 2 at the rope entry opening 6. It is understood that the wedge socket 2 may be cast and/or machined.

FIG. 2 shows a cast and/or machined tapered synthetic rope wedge 3 with a rope passage 3a that allows a braided synthetic rope 4 to pass through without interruption. Also shown are unbraided rope strands 11 at the unbraided end 18 of the braided synthetic rope 4 inserted through the wedge 3 at the rope entry end 8 and extending from the top end 9 of the wedge 3. It is understood that the wedge 3 may be cast and/or machined. The wedge 3 has rounded edges 9a for the protection of the braided synthetic rope 4. While not shown in FIG. 2, another feature of the wedge 3 are grooves 10 on the sides of the wedge 3 to receive the individual strands 11 at the unbraided end 18 of the braided synthetic rope 4 as the individual strands 11 are unbraided and passed back down the sides of the wedge to be braided back into the raided rope below the wedge. It is understood that the number of grooves 10 will match the number of individual strands 11 unbraided from the braided synthetic rope 4.

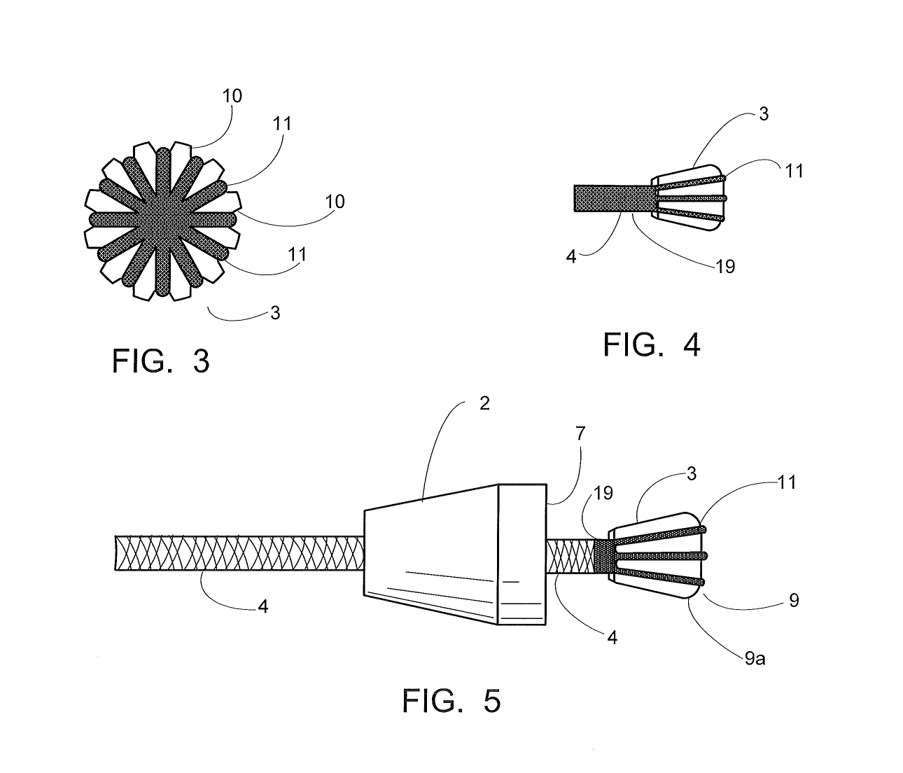

FIG. 3 shows a top view of the braided synthetic rope wedge 3 as the braided rope 4 passes out of the top 9 of the wedge 3, and the rope 4 is unbraided and the individual strands 11 of the rope 4 are passed back down in the grooves 10 in the wedge 3. The grooves are of sufficient depth to protect the rope strands 11 from crushing or cutting when the wedge 3 is pulled back into the wedge socket 2.

FIG. 4 shows a side view of the braided synthetic rope wedge 3 after the braided synthetic rope 3 has been passed through the rope passage 3a at the center of the wedge 3 and then unbraided, each individual strand 11 passed back down the strand grooves 10 in the wedge 3 and rebraided into the braided portion 19 of the synthetic rope 4 below the synthetic rope wedge 3 before the wedge 3 is pulled back to seat in the tapered wedge seat 17 of the wedge socket 2.

FIG. 5 is a side view of the wedge socket 2 and wedge 3 prior to pulling the wedge 3 into the socket 2. Once the braided rope 4 has been passed through the rope entry end 5 at the rope entry opening 6 at the center of the wedge socket 2 uninterrupted, the rope 4 has been unbraided and each individual strand 11 has been passed back down the wedge 3 in the strand grooves 10 and braided back into the braided portion 19 of the rope 4 below the wedge 3. Once the rope strands 11 of the rope 4 have been passed back down the wedge 3 in the strand grooves 10 and braided back into the braided portion 19 of the rope 4 below the wedge 3, the rope 4 and wedge 3 can be pulled back into the wedge socket 2 seating the wedge 3 firmly in place on the tapered wedge seat 17 of the wedge socket 2.

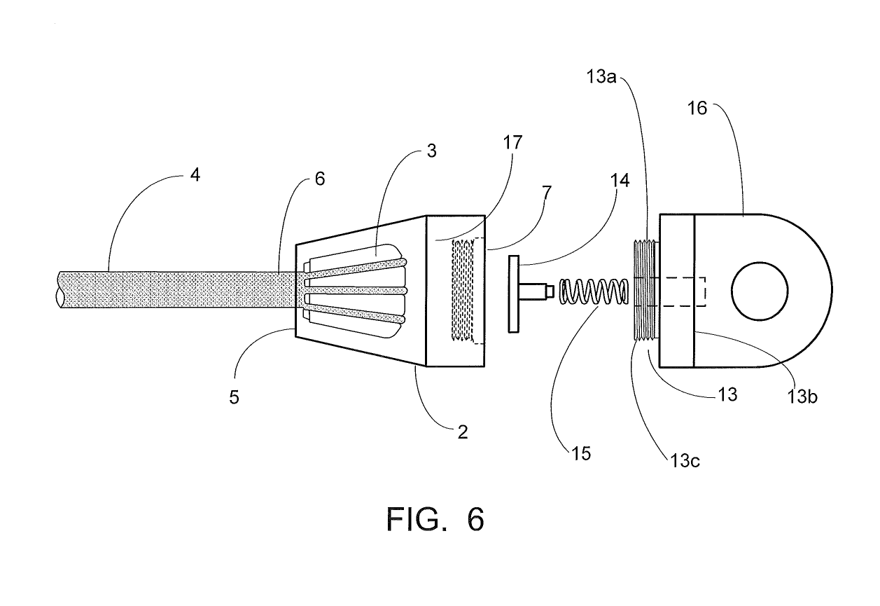

FIG. 6 is a side cross sectional view of the wedge socket 2 with the rope 4 and wedge 3 pulled back and seated inside the wedge socket 2. It also shows the screw-on cap 13 with a wedge socket engagement end 13a, a fitting end 13b and external threads 13c that can be cast and/or machined with a coaxial plunger 14 that can be cast and/or machined, and a coaxial spring 15. Once the rope 4 and wedge 3 are seated in the wedge socket 2 the spring 15 and plunger 14 can be installed in the screw-on cap 13 to be installed in the wedge socket 2. The spring 15 and plunger 14 help to keep the wedge 3 seated in the wedge socket 2 while in use. Other features of the screw-on cap is the end attachment 16 which can be changed or customized for the changes in use or equipment modifications that take place over time. In this figure the end attachment 16 is an eye.

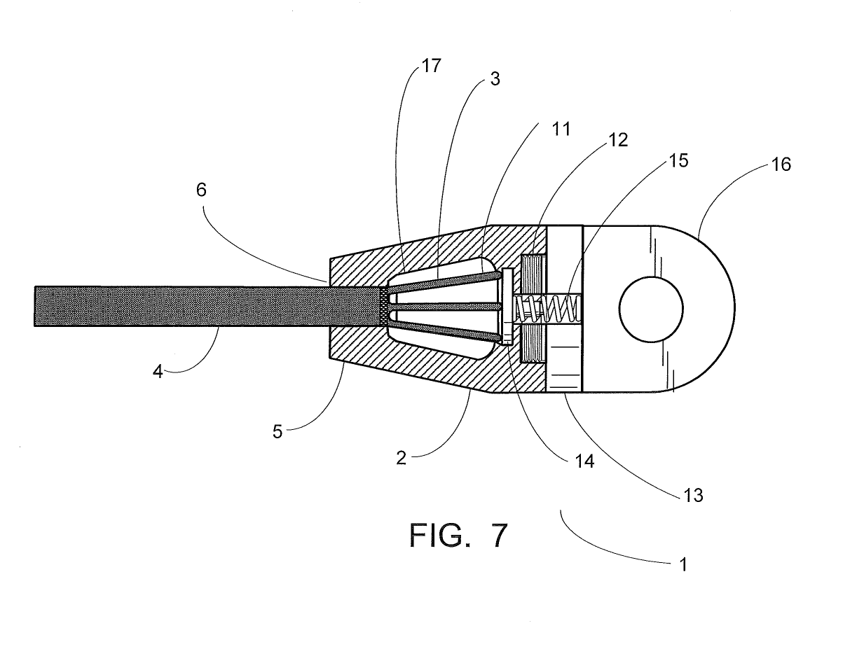

FIG. 7 shows a side cross sectional view of the complete and assembled braided synthetic rope socket 1. The rope 4 has been braided around the rope wedge 3 and seated back in the wedge socket 2. The spring 15 and plunger 14 have been installed in the screw-on cap 13 and the screw-on cap 13 has been installed in the wedge socket 2. The plunger 14 rests against the top 9 of the rope wedge 3 and the compressed spring 15 keeps steady pressure on the plunger 14 to keep the wedge 3 in place. The end connection 16 of the braided synthetic rope socket 1 is an eye.

We claim:

1. A device for the end termination of braided synthetic rope with a multiplicity of braided strands, comprising:
a tapered wedge with a rope entry end, a top end with rounded surfaces, extending from the rope entry end to the top end, and a multiplicity of longitudinal exterior wedge slots to receive strands unbraided from the synthetic rope at the end termination after being extended through the wedge from the rope entry end to the top end, said strands being rebraided into the synthetic rope at the rope entry end of the wedge after being folded back and placed in the wedge slots;
a wedge socket with a rope entry end, a rope entry end opening with rounded edges at the rope entry end for insertion of the braided synthetic rope before said rope is extended through the wedge, a wedge entry end, a tapered wedge seat to receive the tapered wedge, internal threads in the tapered wedge seat at the wedge entry end;
a screw-on cap having a wedge socket engagement end and a fitting end with external threads, coaxial plunger and spring at the wedge socket engagement end for threaded engagement with the internal threads in the tapered wedge seat at the wedge entry end after the tapered wedge is seated in the wedge socket, and;
a socket fitting fixedly attached to the fitting end of the screw-on cap.

2. The device of claim 1 where the socket fitting is an eye socket.

3. A method for the end termination of braided synthetic rope with a multiplicity of braided strands, comprising:
inserting the end of a braided synthetic rope through a wedge socket with a rope entry end, a rope entry end opening with rounded edges at the rope entry end, said wedge socket also having a wedge entry end, a tapered wedge seat to receive a tapered wedge, and internal threads in the tapered wedge seat at the wedge entry end;
inserting the end of the braided synthetic rope after being inserted through the wedge socket into and through a tapered wedge with a rope entry end, a top end with rounded surfaces, extending from the rope entry end to the top end, and a multiplicity of longitudinal exterior wedge slots;
unbraiding the strands from a portion of the end of the braided synthetic rope extending from the top end of the tapered wedge;
folding the unbraided strands back over the tapered wedge into the wedge slots;
rebraiding the unbraided strands extending past the wedge slots into the synthetic rope in proximity of the wedge rope entry end;
pulling the synthetic rope to draw and seat the tapered wedge with unbraided strands placed in the wedge slots in the wedge socket, and;
at the wedge entry end of the wedge socket threading a screw-on cap with a fixed socket fitting, with external threads, a coaxial plunger and spring into the internal threads of the wedge socket, said plunger engaging the top end of the wedge and securing it in the wedge socket.
